(19) United States
(12) Patent Application Publication
(10) Pub. No.: US 2020/0065734 A1
(43) Pub. Date: Feb. 27, 2020

(54) NETWORK COMPUTING SYSTEM TO COORDINATE TIMING OF DELIVERY SERVICES

(71) Applicant: Uber Technologies, Inc., San Francisco, CA (US)

(72) Inventors: Andrew Timothy Szybalski, San Francisco, CA (US); Paul Smith, San Francisco, CA (US); William Danner, San Francisco, CA (US); Michael Stumpo, San Franciscco, CA (US); Sonya Ives, San Francisco, CA (US); Clare O'Brien, San Francisco, CA (US); Wendi Chiong, San Francisco, CA (US)

(21) Appl. No.: 16/111,013

(22) Filed: Aug. 23, 2018

(51) Int. Cl. G06Q 10/06; G06Q 10/08; G06Q 30/06

(52) U.S. Cl. CPC G06Q 10/06315; G06Q 30/0635; G06Q 10/0833

(57) ABSTRACT

A network computing system to coordinate a completion time of at least a portion of an order request with a target completion time, where the target completion time reflects an estimated time of arrival for a transportation provider with respect to a location of the supplier. The network computing system can coordinate the completion time by determining a timing of when at least a step in the preparation of at least the portion of the order request is performed by the supplier, based on an estimated arrival time of a transport provider. The network computing system can perform one or more control actions to influence the target completion time, based on the determined timing.

### TECHNICAL FIELD

Examples described herein relate to a network computing system to coordinate timing of delivery services.

### BACKGROUND

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications (sometimes referred to as “apps”) to communicate with a network service through which an on-demand service is offered.

### BRIEF DESCRIPTION OF THE DRAWINGS

FIG. 1 illustrates a network computing system to coordinate completion of order requests with arrival times of transportation providers, according to one or more examples.

FIG. 2 illustrates an example method for determining interest levels for menu items amongst a population of users.

FIG. 3 illustrates a computer system on which one or more embodiments can be implemented.

FIG. 4 is a block diagram illustrating an example consumer device for use with examples as described.

### DETAILED DESCRIPTION

Examples provide for a network computing system that coordinates the arrival time of transportation providers in picking up delivery orders from suppliers, with the expected completion times of food items in the delivery order. The network computing system can implement actions to control or influence the timing of when, for example, steps in the preparation of an order request is performed at a supplier (e.g., restaurants). The actions can be performed to coordinate an arrival time of a transportation provider with the completion time of an order request. For example, the network computing system can target the arrival time of a selected transportation provider to be within a threshold duration (e.g., two minutes) of the completion time of the order request.

As examples, the network computing system can perform actions that include delaying timing of when an order delivery is communicated to a supplier. The network computing system can also communicate instructions to the food preparation source to initiate, pause or delay an intermediate step in the preparation of a delivery order.

Examples further provide for the network computing system to arrange food delivery from multiple suppliers for the purpose of completing an order request. In such examples, the network computing system can sequence when the respective delivery orders are prepared by each restaurant, based on considerations such as the type of food items being prepared (e.g., ice cream is picked up after a meal dish). Thus, the network computing system can perform actions to implement the timing of when a portion of the order request is prepared at a second restaurant, based on input such as an estimated completion time of the first portion of the order at the first restaurant, and/or an arrival time for a transportation provider at the first restaurant.

Still further, in examples, a network computing system is provided to coordinate a completion time of at least a portion of an order request with a target completion time, where the target completion time reflects an estimated time of arrival for a transportation provider with respect to a location of the supplier. The network computing system can coordinate the completion time by determining a timing of when at least a step in the preparation of at least the portion of the order request is performed by the supplier, based on an estimated arrival time of a transport provider. The network computing system can perform one or more control actions to influence the target completion time, based on the determined timing.

With reference to examples, the term “supplier” is interchangeable with “food preparation source”—common examples of suppliers or food preparation sources include restaurants.

As used herein, a client device refers to devices corresponding to desktop computers, cellular devices or smartphones, wearable devices, laptop computers, tablet devices, television (IP Television), etc., that can provide network connectivity and processing resources for communicating with the system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

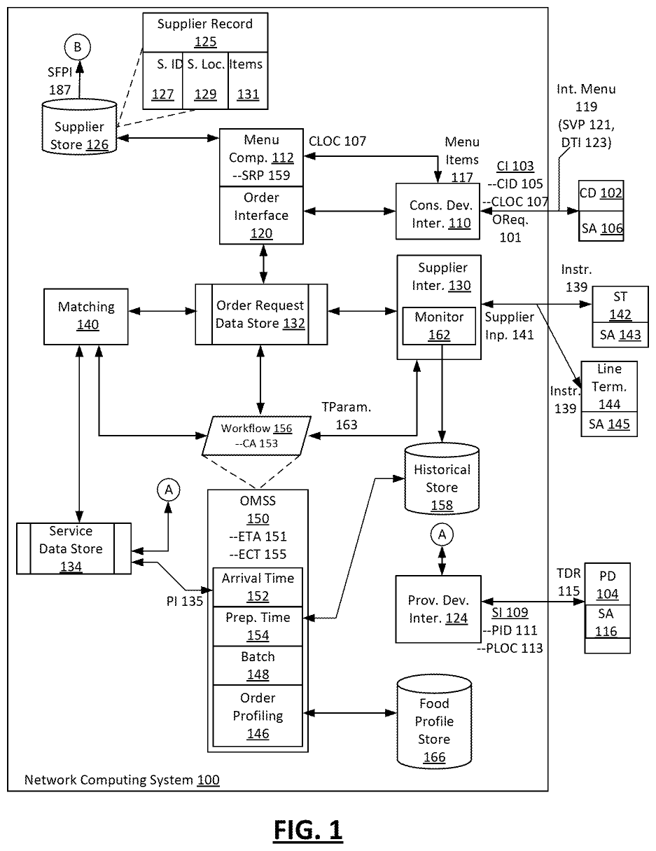

FIG. 1 illustrates a network computing system to coordinate completion of order requests with arrival times of transportation providers, according to one or more examples. In particular, a network computing system 100 implements control actions which target matching a time when a supplier (e.g., restaurant) completes an order request with an arrival time of a transportation provider (e.g., delivery person or transportation provider) at the location of the supplier. In examples, the system 100 can implement actions that direct or otherwise influence the preparation of food items by a supplier (e.g., restaurant) to fall within a target time interval that is also intended to coincide with the arrival of a transportation provider at the location of the supplier. In this way, the system 100 can reduce the occurrence of wait time by transportation providers, while also reducing occurrences of transportation providers arriving “late” (e.g., minutes after when the food items have been prepared), which in turn, may cause the food items to deteriorate or lose their appeal when delivered to the requesting consumer.

With respect to examples as described, the system 100 can be implemented on a server, on a combination of servers, and/or on a distributed set of computing devices which communicate over a network such as the Internet. Still further, some examples provide for the network computing system 100 to be distributed using one or more servers and/or mobile devices. In some variations, the network computing system 100 is implemented as part of, or in connection with a network system, where, for example, operators use service vehicles to provide transport-related services between locations. In variations, the network computing system 100 may be implemented using mobile devices of users, including transportation providers and consumers, with the individual devices executing a corresponding service application that causes the computing device to operate as an information inlet and/or outlet for the network computing system 100.

In some examples, the system 100 implements a network platform, in connection with applications that run on mobile devices of the population of users. The users can include those who order items from the delivery service through their respective computing device (“requesting consumer”), as well as those who receive items from the delivery service as part of a group (collectively termed “consumers” in examples as described). The users can also include suppliers, which can include, for example, operators of restaurants, stores which provide prepared foods, and food preparers (e.g., independent chefs operating in professional kitchens). The providers can include individuals and fleet operators who provide transport services, such as in connection with delivery orders.

With reference to an example of FIG. 1, the system 100 includes a consumer device interface 110, an order interface 120, a provider device interface 124, a supplier interface 130, a matching component 140, and an order management sub-system (“OMSS 150”). Additionally, the system 100 can include one or multiple data stores which maintain information about consumers, suppliers, and providers. As described by some examples, the system 100 can be implemented in connection with a delivery service which enables consumers in a geographic region to request food items from suppliers (e.g., restaurants) for delivery to their respective locations.

As described by various examples, the OMSS 150 performs actions to coordinate a completion time of an order request that is being prepared by a supplier (e.g., restaurant) with an estimated time of arrival of a transportation provider at the location of the supplier. Through performance of such coordination actions, the OMSS 150 can prevent or mitigate against the occurrence of (i) a transportation provider arriving to the location of the supplier on time, and then having to wait an extended period of time for the supplier to prepare the order request which the transportation provider is to deliver; and/or (ii) a supplier completing preparation of an order request before an assigned delivery arrives at the location of the supplier to deliver the order request.

The consumer device interface 110 includes or performs processes that run on the network-side of the system 100 to establish communication channels with individual devices of consumers. The consumers may operate mobile devices (represented in FIG. 1 by the consumer device 102) on which a corresponding service application 106 may execute. The consumers may operate respective service applications 106 to request delivery services, and in some variations, other types of transport-related services, such as human transport between a start location (or pickup location) and a destination (or drop-off). The service application 106 may obtain its current location 107 by interfacing with a satellite receiver or other location-aware resource of the consumer device 102.

According to some examples, the provider device 104 initiates communications with the system 100 using the service application 116. The service application 116 may correspond to a program (e.g., a set of instructions or code) that is downloaded and stored on the provider device 104 of the transportation provider. The transportation provider can launch the service application 116 to utilize the system 100 to receive transport delivery requests 115, and/or another type of service request (e.g., transport requests). The transportation provider may operate a service vehicle to fulfill a transport delivery request 115. Once the communication channel is established by the provider device 104 using the service application 116, the provider device 104 may repeatedly or continuously communicate service information 109 to the network computing system 100. The service information 109 may include the provider's identifier 111, as well as the provider's current location 113, which may be determined by the service application interfacing with a satellite receiver of the provider device 104.

The provider device interface 124 includes or performs processes that run on the network-side of the system 100 to establish communication channels with individual devices of transportation providers. For example, the consumer device interface 110 can establish secure sockets with different types of mobile devices, which transportation providers of the system 100 can utilize when delivering orders and providing other services using their respective vehicles. In some examples, the transportation providers operate mobile devices (represented in FIG. 1 by the provider device 104) on which a corresponding service application 116 may be operated. Among other functionality, the service application 116 can automate operations which include indicating the availability of the transportation provider to provide service, communicating location information to enable the system 100 to monitor the location of the transportation provider's vehicle, receiving information from the system 100 to facilitate the transportation provider in receiving order requests and fulfilling order requests, and/or communicating information to the system 100 for various purposes.

The system 100 may include an active service status store 134 that maintains records that associate individual providers with their respective current location 113 and service status. By way of example, each transportation provider may start a shift by operating the service application 116 (e.g., opening the application on the provider's device 104), and then toggling a state feature provided by the service application 116 to ‘on duty’. The service application 116 communicates the activation of the state feature to the system 100 via the provider device interface 124. The provider device interface 124 processes the service information 109 received from individual transportation providers. For each transportation provider, the provider device interface 124 extracts and stores the current location 113 of the provider device 104 with the provider's identifier 111 in the service status store 134. As the transportation provider's location changes (e.g., with the movement of the transportation provider's vehicle), subsequent communications from the provider device 104 via the provider device interface 124 can be used to update the service status store 134. In this way, the service status store 134 may reflect the most current location of each transportation provider.

In some examples, the consumer device interface 110 and the provider device interface 124 can each include or use an application programming interface (API), such as an externally facing API, to communicate data with the consumer and provider devices 102, 104, respectively. By providing the externally facing API, the system 100 can establish secure communication channels via secure access channels over the network through any number of methods, such as web-based forms, programmatic access via RESTful APIs, Simple Object Access Protocol (SOAP), remote procedure call (RPC), scripting access, etc.

The supplier interface 130 may correspond to a programmatic interface that transmits order requests from consumers to a terminal of a supplier (shown as supplier terminal 142). In the context of food delivery, the supplier interface 130 transmits delivery orders to a computer system (e.g., reservation ordering system, point-of-sale device, dedicated take-out terminal, etc.) of the supplier. In some examples, the supplier may operate a mobile device on which a service application 143 is operated. The service application 143 can enable the supplier to receive service requests from the system 100. The supplier may access the system 100 via, for example, a website or application interface (e.g., supplier service application) to accept order requests, as well as to provide information as to the preparation status of an order request. Additionally, the supplier may access the system 100 to provide menus or descriptions (including text and images) of available items for delivery.

In some variations, the supplier may also operate a line terminal 144 that receives communications 139 from system 100 relating to preparation instructions. In examples, the line terminal 144 can be operated by, for example, a cook, chef or assistant, to coordinate timing of food preparation steps with instructions received from system 100. The line terminal 144 can be implemented as, for example, a mobile computing device on which another service application 145 is operated. As described with other examples, the line terminal 144 can receive instructions for a preparer of an order request, where the instructions specify, for example, (i) a start time and/or target completion time for individual order request, (ii) a pause or delay to preparation of an order request, (iii) a change to the sequence of preparation steps to change the completion time of food items being prepared by the preparer. The line terminal 144 can also receive input from the supplier as to, for example, progress towards completion of a given order request. The service applications 143, 145 for the respective supplier terminal and line terminal 144 can be the same, or the respective applications can be different. For example, the system 100 can configure each of the respective service applications 143, 145 to have different user-interfaces. The service application 145 for the line terminal 144 can be optimized to display information about specific preparation steps of a food item, while the service application 143 of the supplier terminal 142 can render information such as the ETA of specific transportation providers for different order requests.

The system 100 may maintain a supplier profile store 126, which includes a record 125 for each supplier. Each supplier record 125 may associate a respective supplier with an account identifier 127, as well as a supplier location 129 and a set of deliverable items 131 provided by that supplier. The supplier may specify the deliverable items 131 via the supplier interface 130. The deliverable items 131 may be provided as an electronic document, or combination of records provided by the supplier, which can be retrievable and rendered on a consumer device 102 in the form of, for example, an interactive menu. By way of example, the supplier items 131 can be in the form of a restaurant menu, or items for a restaurant menu, which the consumer can render using the service application 106.

According to examples, the consumer device 102 can generate a session request for the consumer device interface 110 when, for example, the service application 106 is launched. The session request may include, or otherwise be transmitted with consumer information 103, which may include an account identifier 105, as well as the current location 107 of the consumer device. In response to the session request being transmitted, the order interface 120 can initiate the order session for the consumer. In some examples, when the order session is initiated, the menu component 112 uses the current location 107 of the consumer to retrieve menu items 117, representing a selection of the supplier's deliverable items 131, from the supplier profile store 126. The menu component 112 can also utilize a service range parameter 159 to select menu items 117 from the supplier's store. The service range parameter 159 can define a distance (e.g., travel distance) from the service location of the desired order request, from which available suppliers may be made available to the consumer for the purpose of delivery orders. Accordingly, the menu component 112 may use the service range parameter 159 in selecting suppliers, from which menu items 117 can be selected. As an addition or variation, the service range parameter 159 can define a range for when a consumer can place a batch order, where portions of a delivery order are prepared by different suppliers who fit a condition or criteria of the range parameter 159.

According to examples, the consumer device interface 110 communicates one or more interactive menus 119 to the consumer device 102, via the service application 106, based on the menu items 117 that match to the current location 107 of the consumer. As described with some examples below, the interactive menus 119 may also communicate one or more service value parameters 121, indicating a charge or consideration which the consumer will incur for receiving delivery of a requested item from the supplier.

The order interface 120 can process the selection input of the consumer during a session. When the consumer selects a food item for an order request 101, the order interface 120 can place an identifier for the selected menu item in a checkout queue for the consumer. Once the order interface 120 signals completion of an order, the order interface 120 can place a corresponding order request 101 in an order request data store 132. The order request 101 can identify each item the requester selected, the supplier the item was selected from, and the delivery location for the order request 101. When the order request 101 is complete, the OMSS 150 can initiate a workflow 156 for the order request 101.

In examples, the OMSS 150 can trigger the matching component 140 to initiate a matching process in which a transportation provider is selected and assigned to the order request 101. The matching component 140 can match the order request 101 to an available transportation provider based at least in part on the current location of individual providers with respect to the location of the supplier. In some variations, the matching component 140 may also match the order request 101 based on the desired arrival time for the provider at the location of the supplier. Thus, for example, the proximity of the transportation provider may not necessarily be a decisive selection criterion for selecting a given transportation provider.

In some variations, the system 100 includes one or more monitoring processes (represented by monitoring component 162) that are performed for completed order requests. The monitoring component 162 can be performed by a supplier to determine timing parameters 163 of individual orders as the orders are prepared and delivered. The monitoring component 162 can determine values for timing parameters 163 that reflect, for example, (i) an order preparation time of an order, (ii) a time to pickup of the completed order, indicating the length of time between when the order request 101 was completed by the consumer and when a transportation provider picked up the corresponding delivery order; and/or (iii) a time to deliver an order, meeting a duration between when a consumer completes an order request 101 and when the transportation provider completes the delivery of the corresponding delivery order to the consumer.

In examples, the monitoring component 162 can also utilize input from the transportation provider (e.g., provided via the provider device interface 124) reflecting, for example, that the transportation provider is waiting at the supplier's location for a delivery order. The monitoring component 162 may also receive input from the supplier reflecting, for example, that the transportation provider has arrived and/or departed the location of the supplier with a delivery order. Still further, the monitoring component 162 can receive input from a beacon or other specialized resource at or near a location of the supplier, to detect proximity of designated individuals using proximity detection resources (e.g., via detection of Bluetooth signal transmission or Near Field Communication (NFC) signals). Based on the various inputs, the monitoring component 162 can determine the actual completion time for food items of a supplier. In such examples, the monitoring component 162 can record historical information for individual suppliers with a historical data store 158. In this manner, the historical data store 158 can record completion times for individual suppliers, as well as for individual food items of a supplier. The historical data store 158 can also reference the recorded completion times to contextual information, such as the time of day or day of week. The recorded completion times can be obtained from, for example, parametric information communicated by the monitoring component 162, the supplier profile store 126, and/or information reported by the suppliers.

In examples, the monitoring component 162 can also obtain information to record for individual suppliers and their respective food items using feedback from consumers. For example, consumers can be prompted to provide feedback for a particular supplier, at which time the consumer can reflect information such as the delivery time for the particular order request. The feedback can be recorded with the supplier profile store 126, which the monitoring component 162 can access and record as historical information for the supplier. As an addition or variation, the supplier can provide a completion time log that indicates the preparation time for individual order requests.

In some examples, the monitoring component 162 can also obtain and record contextual information as feedback for completed order requests 101. The monitoring component 162 can obtain contextual information such as relating to weather, traffic, or other events from, for example, the consumer device 102 used to place an order and/or third-party sources.

In examples, the system 100 can include a food profile store 166 which correlates food items of the supplier menu items with information that identifies a recipe and/or preparation steps of the respective food item. The food profiling information can include, for example, (i) a list of ingredients used in a respective food item that is selected for an order request, and/or (ii) a recipe for preparing the food item, including identification of preparation steps. The food profiling information can also include information that identifies a manner in which each food item is prepared (e.g., blackened, sautéed, cooking temperature or time, type of cooking (e.g., flash-fry)), as well as a temperature or form in which the food item is to be presented for a consumer.

With further reference to FIG. 1, the OMSS 150 implements processes to coordinate a completion time of items of an order request, or portions thereof, with an estimated arrival time of a transportation provider that is to deliver the order request to a location of a requesting consumer.

According to examples, the OMSS 150 implements workflows 156 for individual order requests. For a given order request, the OMSS 150 can, for example, preselect a set of operations to perform over a given time interval during which the order request is prepared by a supplier and a transportation provider is selected to pick up the prepared order request. Once the OMSS 150 initiates the workflow 156, events and signals may cause the OMSS 150 to alter the workflow 156 in a manner that promotes an objective of coordinating the transportation provider's arrival time at the location of the supplier with the completion time of the order request. Accordingly, for a given order request 101, the OMSS 150 can implement the workflow 156 to perform one or more coordination actions 153 to coordinate the arrival times of a transportation provider with a completion time of the order request. The coordination actions 153 can include actions that facilitate or otherwise influence the arrival time of a given transportation provider at a location of a respective supplier for the order request, as well as facilitate or influence the completion time of the prepared food items specified by the order request.

In some examples, the OMSS 150 can perform one or more coordination actions 153 that include specifying a parameter or setting that controls when another programmatic process of the system 100 performs another action related to food preparation and/or delivery of an order request. In other aspects, the OMSS 150 can perform one or more coordination actions 153 that include triggering another programmatic process to perform an action related to food preparation and/or delivery of an order request. Still further, in other aspects, the OMSS 150 can perform one or more coordination actions 153 that include communicating instructions or information to parties (e.g., supplier and transportation provider) of an order request.

In other variations, the coordination actions 153 that the OMSS 150 may perform can include monitoring activities, including monitoring selected transportation providers in their progress towards a location of a supplier, and monitoring suppliers in the progress of completing an order request. In examples, the OMSS 150 can monitor transportation providers to obtain more accurate estimates of the arrival time of the transportation providers. Additionally, the OMSS 150 can monitor suppliers to update the estimates of completion times for respective order requests.

The OMSS 150 can perform the coordination actions 153 with an objective of targeting the actual arrival time of the transportation provider to be within a threshold duration of the completion time of the order request 101. For example, the OMSS 150 can perform one or more coordination actions to cause, or otherwise influence the arrival time of a selected transportation provider to be within X (e.g., 1, 2, 3 etc.) minute(s) of the completion time of the food items of the order request 101. Likewise, the OMSS 150 can perform one or more coordination actions 153 to cause, or otherwise influence the completion time of the order request 101 to be within a designated time interval that coincides with the estimated arrival time of a selected transportation provider for a given order request 101.

Still further, in other variations, the OMSS 150 can perform the coordination actions 153 with an additional objective of targeting the actual arrival time of the transportation provider to precede the actual completion time of the prepared order, where the actual arrival time precedes the actual completion time by no more than a threshold time interval. As an example, the OMSS 150 can perform the coordination actions 153 to target the actual arrival time of the transportation provider to precede the completion time of the order request by no more than 2 minutes.

In some variations, the system 100 can also divide individual order requests 101 into portions that are fulfilled by different suppliers. In such examples, the OMSS 150 can perform coordination actions 153 that sequence completion times of respective portions of individual order requests at different suppliers.

Estimation of Arrival Time

In more detail, an example of FIG. 1 provides for the OMSS 150 to utilize arrival time logic 152 to estimate, for individual order requests, the arrival time of selected transportation providers at the location of corresponding suppliers, where food items of the respective order requests are prepared. The arrival time logic 152 can utilize information from the service data store 134 to obtain provisioning information 135 for a sub-region of individual suppliers. For a given order request, the provisioning information 135 can include, for example, estimations of (i) a number of transportation providers who are within a sub-region of a respective supplier for the order request; (ii) a number of transportation providers who can travel to the location of the respective supplier within a threshold period of time; (iii) a number of pending order requests for which corresponding transportation providers have been assigned; and/or (iv) a number of open order requests for which corresponding transportation providers have not been assigned.

In examples, the arrival time logic 152 can use or access provisioning functionality to determine provisioning information 135 by monitoring transport providers in a given region, via, for example, the service data store 134. The provisioning functionality can estimate the provisioning information 135 from monitoring the transport providers that are indicated as being active with the service data store 134, and further by determining a number of available transportation providers for delivering the completed order request at one or more instances after the order request is received. In such examples, the arrival time logic 152 can determine the ETA 151 based in part on the estimated time interval which the matching component 140 may require to select a transport provider from the available providers.

In some examples, the arrival time logic 152 can also repeatedly predict a trip duration (or portion thereof) of a selected transportation provider from the provider's current location to the location of the supplier. The arrival time logic 152 can utilize, for example, the service data store 134 to obtain a recent or current location of individual transportation providers who have been assigned for delivering completed order requests.

As an addition or variation, the provisioning information 135 can also include prospective indicators of service requests and/or order requests, such as an estimate of a number of potential requesters for transport services provided through the system 100. The potential requesters may correspond to, for example, users who have opened one or more service applications from which order requests and/or transport requests can be (but have not been) made.

In variations, the OMSS 150 can utilize the arrival time logic 152 to estimate the arrival times for transportation providers at the location of suppliers based at least in part on historical information relating to the arrival time for transportation providers at specific locations of individual suppliers, and/or within a sub-region that includes the location of individual suppliers. By way of example, the arrival time logic 152 can utilize a specific time interval (e.g., time of day and day of week) and location or sub-region of a given supplier, in order to predict the arrival time for a transportation provider at the location of the supplier. The arrival time logic 152 can also utilize other contextual information, such as weather or event information, to predict the arrival times of transportation providers at the locations of respective suppliers.

In some examples, the OMSS 150 utilizes the arrival time logic 152 to estimate the arrival time for an order request 101 in advance of a transportation provider being selected for the order request 101. For a given order request 101, the estimation of the arrival time can include separate determinations of at least one of (i) an estimated duration to match a transportation provider to an order request, and (ii) an estimated duration for a matched transportation provider to travel to the location of the supplier.

In some aspects, the arrival time logic 152 is provided as a service that generates an estimated time of arrival (“ETA”) 151 for the OMSS 150, where the ETA 151 identifies a window of time during which a transportation provider is most likely to arrive at the location of a supplier. The OMSS 150 can specify the location of the supplier at a current instance to determine the ETA 151. Once the ETA 151 is obtained for a given order request, the OMSS 150 can determine one or more coordination actions 153 (if any) to perform to influence the completion time of the respective order request.

Additionally, the OMSS 150 can obtain the ETA 151 without triggering the matching component 140 to select a transportation provider. Rather, the 152 can be implemented to generate, for example, a phantom transport request, from which the matching component 140 makes a phantom selection of a transportation provider (e.g., transportation provider is not notified about the selection). Once obtained, the OMSS 150 can receive or otherwise determine updates to the ETA 151.

In some examples, the OMSS 150 can utilize the ETA 151 to perform the coordination action 153 of triggering, or otherwise causing the matching component 140 to initiate a matching process for selecting a transportation provider to handle an order request. Thus, for example, the OMSS 150 can utilize the ETA 151 (as obtained without an actual transportation provider being matched) to delay, or set a future time (e.g., 5 minutes later) when the matching component 140 is to be triggered into selecting a transportation provider for delivery of a given order request. The OMSS 150 can also utilize the ETA 151 to implement the coordination action 153 of timing when, for example, the order request 101 is communicated to a specified supplier.

Estimation of Completion Time

The OMSS 150 can utilize preparation time logic 154 to determine an estimated completion time (“ECT”) 155 of individual order requests by respective suppliers. In examples, the ECT 155 corresponds to an estimated window of time, such as provided by a probabilistic determination that is predictive as to when a given supplier is most likely to complete preparation of the food items of a given order request 101. In variations, the estimated completion time 155 can further correspond to the time when an order request 101 is ready for pickup by a transportation provider. Thus, the ECT 155 can take into account a time which the supplier may need to package a food item for delivery.

In some examples, the OMSS 150 can use the preparation time logic 154 to determine the ECT 155 of the order request 101. In turn, the 150 can determine, as part of the workflow 156, when one or more steps in the preparation of individual food items for the order request are to be performed, based on the ECT 155.

In some examples, the preparation time logic 154 utilizes historical information (e.g., such as provided from historical data store 158), relating to the preparation time of food items by suppliers, to determine the ECT 155 for individual order requests 101. As an addition or variation, the preparation time logic 154 can determine the ECT 155 from completion time reports provided by the suppliers. For example, suppliers may associate completion times with menu items via the supplier interface 130. In variations, the suppliers can respond to receiving an order request 101 from system 100 with supplier input 141 that identifies an estimated completion time for the order request 101. Still further, the preparation time logic 154 can determine the ECT 155 based on a predicted preparation time of individual food items, such as the food item of an order request that is expected to take the longest to prepare.

As an addition or variation, the preparation time logic 154 can determine the ECT 155 for an order request 101 by monitoring recent order requests of the supplier. For example, the preparation time logic 154 can estimate the ECT 155 from parametric information determined by monitoring other order requests 101 to the same supplier from an earlier time period (e.g., in past hour). For example, the preparation time logic 154 can tune or weigh the ECT 155 to account for delays, detected by monitoring component 162.

In some examples, the preparation time logic 154 maintains preparation times of individual food items on menus of individual suppliers. For example, the preparation time of individual food items can be determined based on the recipe used for each food item. The preparation time logic 154 can utilize, for example, a library of food preparation times to determine the ECT 155 for an order request 101. The preparation time logic 154 can also correlate preparation times to observed completion times to calibrate, for example, the determinations of ECT 155. For example, the supplier may be observed to generally require at least 10 additional minutes to prepare and package a food item, as compared to the preparation time provided by a recipe for the food item. Additionally, the preparation time logic 154 can further adjust the ECT 155 to accommodate, for example, specific food items on individual menus which have longer preparation times.

Workflows

As described with various examples, the OMSS 150 implements workflows 156 for individual order requests that are received via the order interface 120. In implementing a workflow 156 for a given order request, the OMSS 150 can (i) use the arrival time logic 152 to obtain the ETA 151 for the order request 101, and (ii) use the preparation time logic 154 to determine the ECT 155 for the order request 101 by the specified supplier. The OMSS 150 can configure the workflow 156 by intelligently selecting instances when the specified supplier begins to prepare the order request 101. The OMSS 150 can also configure the workflow 156 to trigger the matching component 140 to initiate a matching process for selecting a transportation provider of the order request 101, at an instance that is determined by the ETA 151 and the ECT 155. If the ECT 155 exceeds the ETA 151, the OMSS 150 can communicate the order request 101 to the supplier to initiate preparation of the order request 101. The OMSS 150 can then trigger the matching component 140 to initiate the matching process based on the ETA 151, such that a difference between the ECT 155 and the ETA 151 is within a threshold time interval.

On the other hand, if the ETA 151 exceeds the ECT 155, the OMSS 150 can implement, as part of the workflow 156, a coordination action 153 that triggers or otherwise influences the moment when the supplier begins preparation of the items of the order request 101. The coordination action 153 can correspond to, for example, (i) timing when the supplier receives the order request 101, and/or (ii) communicating instructions to the selected supplier to influence the completion time of the order request. As examples instructions can communicate, for example, (i) the time when the selected supplier should start beginning preparation of the order request 101, (ii) the time (or window of time) during which the transportation provider should have the order request 101 completed, and/or (iii) a delay time or action that the supplier should perform before the supplier begins preparation of the order request, or alternatively, performs an intermediate step in the preparation of the food items for the order request.

In some examples, the OMSS 150 can perform one or more monitoring processes to adjust a workflow 156 that is initiated for a given order request 101. When, for example, the matching component 140 is triggered to find a matching transportation provider, the OMSS 150 can receive one or more updates from the matching component 140 to communicate a status of the order request 101. For example, the OMSS 150 can receive updates from the matching component 140 which indicate the order request 101 has just been assigned to a transportation provider. If the order request 101 is unassigned, the updates from the matching component 140 can, for example, update the OMSS 150 as to the ETA 151, to accommodate, for example, delays in matching the order request 101 to a transportation provider. Still further, the matching component 140 can provide an update to the OMSS 150 to reflect that an assigned transportation provider has been reassigned, or is otherwise unavailable. Still further, the OMSS 150 can communicate with, for example, the provider status store 134 to track the location of the transportation provider. The OMSS 150 can use the arrival time logic 152 to recalculate the ETA 151 to account for the progress of the selected transportation provider on route to the location of the supplier of the order request 101. For example, the OMSS 150 can also use the arrival time logic 152 to lessen or lengthen the ETA 151 from the original calculation made with initiation of the workflow 156 of the order request 101.

In some examples, the OMSS 150 can also adjust the workflow 156 based on monitoring of the supplier's progress in completing an order request 101. The supplier can provide, for example, supplier input 141 via the supplier terminal 142. Depending on implementation, the supplier input 141 can indicate, for example, (i) that the supplier is delayed in preparing a given order request 101, or specific item of an order request 101; (ii) that the supplier is on-time or ahead of schedule (e.g., such as the estimated completion time), and/or (iii) an updated estimated completion time for the order request 101. Still further, the supplier input 141 can indicate completion of specific milestones in the preparation of an order request 101. By way of example, the milestone signified by the supplier input 141 can include (i) the supplier beginning preparation of a food item for an order request, (ii) the supplier completing an item of an order request, or (iii) the supplier completing preparation of all of the items of the order request 101, with packaging or other final step remaining.

In some variations, the OMSS 150 can adjust the ECT 155 of a corresponding workflow 156 based on timing parameters 163 detected by the monitoring component 162. For example, the monitoring component 162 can detect completion times of immediately preceding order requests for the same supplier to increase from their respective expected completion times. Thus, the monitoring component 162 can be used to predict events, such as delays by the supplier, in absence of input from the supplier.

In examples, the OMSS 150 can adjust the workflow 156 for a given order based on detection of monitored events or conditions. In examples, the OMSS 150 adjusts the workflow 156 of a given order request 101 through implementation of one or more coordination actions 153. In this way, the OMSS 150 can implement workflows 156 for order requests 101 that are dynamic, to adjust for events and conditions that can affect the arrival time of transportation providers and/or the completion time of order requests by suppliers. Through adjustment of workflows 156, the OMSS 150 can improve the likelihood that transportation providers arrive at the locations of suppliers to pick up assigned delivery orders at approximately the same time (e.g., within a threshold time interval) as when the respective order requests are complete and ready for delivery.

In examples, the OMSS 150 can respond to a detected delay in the ETA 151 of a transportation provider by altering the workflow 156 to include performing a coordination action 153 that targets delaying when a supplier begins preparation of an order request 101, or portion thereof. In such an example, the OMSS 150 can cause the system 100 to delay sending a communication 139 to the supplier terminal 142 that identifies the order request 101 to the supplier. As an addition or variation, the OMSS 150 can send one or multiple communications 139 to the supplier terminal 142, providing instructions that indicate that the supplier is to wait to a specific start time before beginning preparation of the order request 101. Still further, the OMSS 150 can configure the communications 139 that are sent to the supplier terminal 142 to specify an updated or new completion time for the order request. For example, the OMSS 150 can implement the workflow 156 to send a first communication 139 to the supplier terminal 142 that identifies the order request and specifies a completion time, then subsequently send a second or third communication 139 to update the completion time of the order request, as a response to events which the OMSS 150 may have detected or otherwise monitored.

As an addition or variation, the OMSS 150 can be responsive to a detected delay in the ETA 151 of a transportation provider by performing a coordination action 153 that is targeted to delay the completion time of the order request. The coordination action 153 can correspond to a follow on communication 139 that instructs the supplier to pause preparation of the order request 101, or to otherwise delay the completion time of the order request by a specified duration. For example, the coordination action 153 can include sending an instruction to the supplier to delay performing an intermediate or final step in the preparation of one or more food items of an order request.

In some examples, the OMSS 150 can utilize order profiling logic 146 to identify specific requirements or steps in the preparation of individual food items of an order request 101. In an aspect, the OMSS 150 utilizes the order profiling logic 146 to identify food items of a given order request 101 which have a limited delivery time health before the desirability of the food item is significantly deteriorated or otherwise deemed unacceptable for the consumer. The order profiling logic 146 can reference, for example, the food profile store 166 in order to identify specific aspects of individual food items which can or should be accommodated when provided through delivery. As an example, the OMSS 150 can utilize the order profiling logic 146 to identify food items that are required to be served in a frozen or chilled state (e.g., ice cream, ice cream cake, raw seafood prepared on layer of ice, etc.). As another example, the OMSS 150 can utilize the order profiling logic 146 to identify food items that have limited delivery time health, meaning food items which lose their structure and/or desirability over a relatively short period of time (e.g., Caesar's salad, soup in a bread bowl, etc.). The order profiling logic 146 can, for example, utilize the food profile store 166 to maintain a list of such food items, as well as to determine an optimal or acceptable delivery time for such food items.

In examples, the OMSS 150 implements the workflow 156 to perform coordination actions 153 that are targeted to sustain the desirability of food items that have limited delivery time health. In implementing a workflow 156 for a given order request 101, the OMSS 150 can separately specify timing instructions as to when the supplier is to initiate preparation of one or more food items in the order request that have limited delivery time health. For example, the OMSS 150 may specify instructions to initiate preparation of such food items based on the ETA 151 and/or the ECT 155. The instructions may specify, for example, a time interval preceding the ETA 151 or ECT 155, but after when the supplier has initiated preparation of other items of the order request 101, during which the supplier is to initiate preparation of a food item having a limited delivery time health. To illustrate, the instructions may inform the supplier to scoop ice cream and/or cut a slice of ice cream cake for a dessert portion of an order request 101, a set number of minutes (e.g., 3 minutes) before the ETA 151. The OMSS 150 may also implement the workflow 156 to separately send and/or update the instructions for food items with limited delivery time health. Thus, for example, the OMSS 150 can monitor the transportation provider by tracking the transportation provider's current location via the service status store 134, and can cause the supplier to initiate preparation of the food items with limited delivery time health just before the arrival of the transportation provider at the location of the supplier.

In other variations, the OMSS 150 can identify the preparation steps of individual food items, and further vary the manner in which a given preparation step is performed during the preparation of a given food item for an order request. The preparation steps for food items can be maintained with, for example, the food profile store 166, which the OMSS 150 can access when implementing the order profiling logic 146. The OMSS 150 can implement the order profiling logic 146 to identify preparation steps in the course of the preparation of food items which can be subject to variation, for purpose of enabling the supplier to alter (e.g., delay) when an order request is prepared. By way of illustration, the preparation of some food items can include a final step (e.g., pouring of sauce), after which the food item starts to lose its desirability. The determination of food items which lose desirability can also be determined from feedback of the consumers for the same food items. For example, feedback from consumers can indicate a time frame when specific food items lose their desirability (e.g., due to loss of temperature), even in cases where food items maintain their structure.

The OMSS 150 can utilize the order profiling logic 146 to identify those food items of a given order request 101 which are subject to a step which causes the food items to have a limited delivery time health. In such examples, the OMSS 150 can implement the workflow 156 to, for example, communicate an instruction to the supplier to signal a time when the particular step (e.g., last step) should be performed, in order for a desired completion time to be achieved (e.g., delayed completion time). The OMSS 150 can also utilize the order profiling logic 146 to track preparation of the specific food item of the order request 101. The OMSS 150 can then implement the workflow 156 to provide the instruction for initiating the particular preparation step at an appropriate time.

Still further, the OMSS 150 can utilize the order profiling logic 146 to identify preparation steps which can be subject to time-based variations. For example, some preparation steps can be performed for an extended period of time without affecting the outcome of the preparation step (e.g., simmering sauce for extra minutes). Other preparation steps can be performed concurrently in order to accelerate the completion time of the prepared food item. Utilizing the order profiling logic 146, the OMSS 150 can implement the workflow 156 to specify coordination actions 153 that include instructing the supplier to vary the performance of individual preparation steps, in order to alter when preparation of the corresponding food item is complete. Thus, for example, the OMSS 150 can perform coordination actions 153 that include instructing the supplier as to, for example, (i) a time when a final step in the preparation of the food item is to be performed, (ii) a time interval for performing a particular preparation step (e.g., simmering), and/or (iii) a timing of when a given preparation step is performed relative to another preparation step.

In some variations, some food items may be associated with a threshold wait time, corresponding to a duration from when the food is packaged until it is delivered, after which the food item is deemed to lose desirability. In examples, the threshold wait time for specific food items can be determined from feedback provided by consumers, operating consumer devices 102. For example, the consumers can provide negative feedback relating to the desirability of the food items as a result of passage of time (e.g., “bread is soggy and cold”). The feedback can be aggregated via the supplier profile store 126, along with the wait time for the incidents of negative feedback. Based on the wait times where negative feedback was received for a given food item, the system 100 can determine the threshold wait time for a given food item of a supplier. When the OMSS 150 implements the workflow 156, the timing considerations can further take into account threshold wait times for individual food items. The coordination actions 153 can further identify the threshold wait times for individual food items, and further promote timing to avoid exceeding the threshold wait times for individual food items of an order request. By way of example, the OMSS 150 can implement a sequence of preparation by the supplier(s), as well as delays in the preparation of food item with low threshold wait times, such that the food items are not prepared until near arrival of the transportation provider.

Timing of Batch Orders

In some examples, the system 100 can implement batch ordering, in which individual order requests are distributed to multiple suppliers. For example, a requester can specify food items for a dinner order from a first supplier, and dessert items from a second supplier. The system 100 may implement batch ordering as a condition or setting, which may be selectively implemented when as needed. When batch ordering is enabled, the order interface 120 can accept selection of menu items from the requesting consumer in which the selections identify food items from multiple separate suppliers. The system 100 can enable the batch ordering to be implemented in accordance with predetermined criteria, such as criteria of spatial proximity as between suppliers that received different portions of a consumer's order request.

Additionally, the OMSS 150 can configure the workflow 156 to account for the estimated or predicted the preparation time of the portion of the order request with the second supplier. In such examples, the OMSS 150 can make the determination based on the profile of the second supplier (e.g., as provided by the historical profile store 158) and/or the type of food being provided by the second supplier. Still further, the configuration of the workflow 156 can account for a distance and/or travel time between the location of the first supplier and the location of the second supplier, as well as between the location of the second supplier and the location of the requesting consumer. By configuring the workflow 156, the OMSS 150 can identify and implement triggers in the workflow 156, where the triggers coincide with detected events (e.g., passage of time, such as five minutes prior to the arrival of the transportation provider at the location of the first supplier) or conditions (e.g., pickup of first portion of order request at first supplier). When triggers are detected to occur in the workflow 156 with respect to a given order request, the OMSS 150 can perform a related coordination action 153 (e.g., send communication to second supplier to initiate preparation of portion of order request with the second supplier).

According to examples, when batch ordering is to be provided for a given order request, the OMSS 150 can configure the workflow 156 to account for the transportation provider having to travel to two (or more) supplier locations in order to deliver a completed delivery order to the requester. The OMSS 150 can perform separate actions of communicating respective portions of an order request to each supplier. As an addition or variation, the OMSS 150 can implement actions of initiating a matching process to select a transportation provider for the batch order, as well as to monitor the transportation provider's progress towards picking up each portion of the order request at the location of the respective supplier. In examples, the OMSS 150 can implement the workflow 156 to perform coordination actions 153 that target the arrival time of the transportation provider at each supplier location to coincide with the completion time of each portion of the respective order request.

In examples in which batch ordering takes place, the OMSS 150 can configure the workflow 156 to determine a sequence for the transportation provider to follow in picking up different portions of the order request. In some examples, the sequence determination can be based on a type of food item that one or both of the suppliers are preparing. The OMSS 150 can implement batch logic 148 in configuring the workflow 156 to accommodate multiple suppliers and pickups. By way of example, the batch logic 148 can provide that if one supplier is providing a food item for an order request that has limited delivery time health, then the workflow 156 should sequence the transportation provider to arrive at the location of that particular supplier last, based on the assumption that the delivery time (or time from when delivery order is picked to time when delivery order is delivered to consumer) for the item with the limited delivery time health will be minimized. In variations, the workflow 156 can sequence pickups of the portions of an order request based on analysis of food items of the order request. The sequence can, for example, identify the portion of the order request which are least likely to lose desirability, such as in the case when one supplier can provide packaging to maintain a desired temperature of a food item for a respective portion of the order request, while another supplier cannot.

In examples, the OMSS 150 can instruct one or multiple suppliers as to (i) a start time, identifying when the respective supplier is to initiate preparation a respective food item or portion of an order request; and/or (ii) the ECT 155 for the respective supplier, indicating when the respective supplier is to complete their respective portion of an order request. As described with other examples, the OMSS 150 can influence or control the start time for individual suppliers by controlling when the supplier receives the order request (or portion thereof). As an addition or variation, the OMSS 150 can control when the supplier starts preparation of the order request by specifying the start time in an instruction to the supplier.

In examples, the start time for preparation of an order request can represent a milestone in the workflow 156 from which other events can be monitored, and respective coordination actions performed. For example, the workflow 156 can be configured to initiate the matching process for a transportation provider at a set time interval after preparation of the order request is initiated. Similarly, the workflow 156 can be implemented to coordinate other actions about milestones pertaining to the delivery transport, such as the selection of the transportation provider, a progress of the transportation provider at arriving at a location of the supplier, and/or arrival of the transportation provider at the supplier's location. For example, the workflow 156 can trigger when the second supplier of the batch order is to initiate preparation of the second portion of the order request based on the ECT 155 of the first supplier. As another example, the workflow 156 can trigger when the second supplier of the batch order is to initiate preparation of the second portion of the order request based on the ETA 151 for arrival of a transportation provider to the location of the first supplier.

Still further, in other variations, the OMSS 150 can also estimate a variance or delay time between when the supplier is instructed to initiate preparation of a portion of an order request through monitoring and profiling of the supplier from prior order requests. For example, the supplier may provide feedback or other input each time the supplier initiates preparation of an order request, or the OMSS 150 may model the actual preparation time for a food item with the average completion time detected from a supplier to determine and implement variances in the start time of individual suppliers.

In some examples, the OMSS 150 can further configure the workflow 156 to include triggers for implementing events (e.g., initiate preparation of second portion of order request) with a second supplier, in response to detecting milestones, events or conditions with respect to the transportation provider's arrival at the location of the supplier for the first portion of the order request. Thus, for example, if the OMSS 150 determines that the selected transportation provider will be late (e.g., arrive after the initial predicted arrival time) in arriving to the location of the first supplier, the OMSS 150 can send an instruction, or perform another action to cause the second supplier to delay the start and/or completion of the second portion of the order request. Likewise, if the OMSS 150 determines that the first supplier is delayed in completing their respective portion of the order request, the OMSS 150 can similarly perform an action (e.g., send a communication to the second supplier, delay sending portion of order request) that causes the second supplier to delay the start and/or completion of the second portion of the order request.

### Methodology

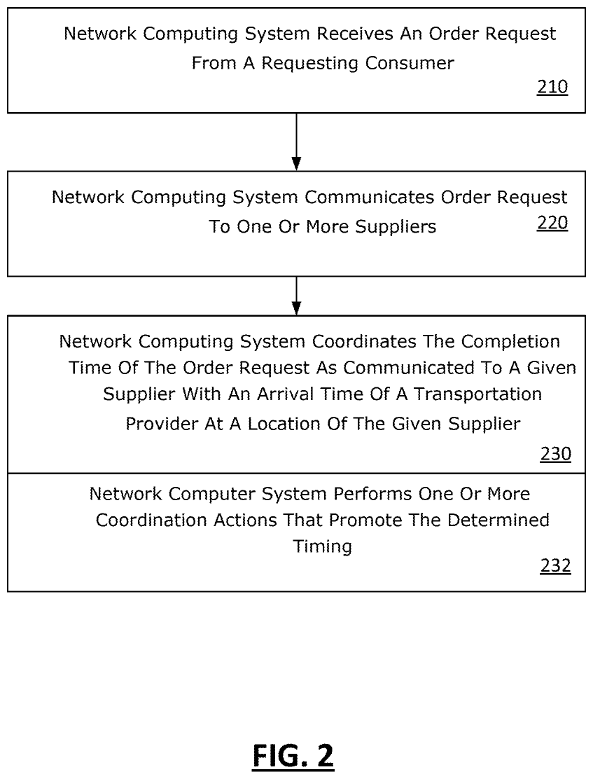

FIG. 2 illustrates a method for coordinating completion of order requests with arrival times of transportation providers, according to one or more examples. In describing examples of FIG. 2, reference is made to elements of an example of FIG. 1 for the purpose of illustrating a suitable component for performing a step or sub-step being described.

With further reference to an example of FIG. 2, the system 100 can receive an order request 101 from a requesting consumer (210). By way of example, the 101 can be received from the consumer interacting with the service application 106, to view interactive menus from one or more restaurants. In some variations, the order requests can specify two or more restaurants as a batch order.

The system 100 can communicate the order request 101 to one or more suppliers (220). For example, the system 100 can communicate the order request 101 to a restaurant of the selected menu items. The order request can be communicated through, for example, a service application 143 operating on a mobile computing device of a proprietor manager of the restaurant. When a batch order is received, a respective portion of the order request 101 is communicated to each restaurant specified by the consumer in the order request.

The system 100 can perform operations to coordinate the completion time of the order request (or portion thereof) communicated to a given supplier with an arrival time of a transportation provider at a location of the given supplier (230). The system can coordinate the completion time by determining a timing of when at least a step in the preparation of the order request (or portion thereof which is with a particular supplier) is performed, where the timing is based on the estimated arrival time of the transportation provider to the location of the respective supplier. In some examples, the system 100 coordinates the completion time to occur within a designated time interval from the estimated arrival time of the transportation provider.

In examples, the one or more processors coordinate the completion time by performing one or more coordination actions that promote the determined timing (232). As described with various examples, the OMSS 150 can perform coordination actions 153 to, for example, delay the predicted completion time of an order request with a restaurant. To illustrate, the OMSS can perform coordination actions 153 that cause delay of when preparation of the order request 101 is initiated, and/or when intermediate or final steps in the preparation of the order request or performed by the restaurant.

In variations, the OMSS 150 can also perform coordination actions 153 to delay the arrival time of the transport provider at the location of the restaurant. For example, the OMSS 150 can time when matching is performed to select and assign a transportation provider to an order request.

Computer System

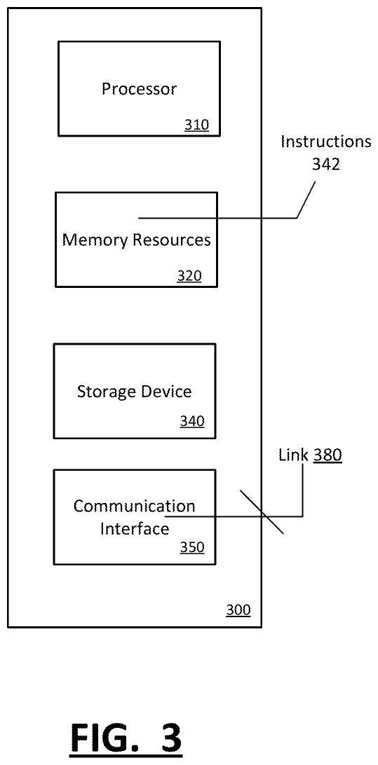

FIG. 3 illustrates a computer system on which one or more embodiments can be implemented. A computer system 300 can be implemented on, for example, a server or combination of servers. For example, the computer system 300 may be implemented as part of the network computing system of an example of FIG. 1. Likewise, the computer system 300 can implement a method such as described with an example of FIG. 2.

In one implementation, the computer system 300 includes processing resources 310, memory resources 320 (e.g., read-only memory (ROM) or random-access memory (RAM)), a storage device 340, and a communication interface 350. The computer system 300 includes at least one processor 310 for processing information stored in the memory resources 320, such as provided by a random-access memory (RAM) or other dynamic storage device. The memory resources 320 can store information and instructions which are executable by the processor 310. The memory resources 320 also may be used for storing temporary variables or other intermediate information during execution of instructions to be executed by the processor 310. The computer system 300 may also include the memory resources 320 or other static storage device to store static information and instructions for the processor 310. The storage device 340 can be in the form of, for example, a solid disk drive, hard drive, mass storage memory, optical disk and the like, to store information and/or instructions for performing examples as described.

The communication interface 350 enables the computer system 300 to communicate with one or more networks (e.g., cellular network) through use of the network link 380 (wireless or a wire). Using the network link 380, the computer system 300 can communicate with one or more computing devices, specialized devices and modules, and/or one or more servers. The executable instructions stored in the memory 320 can include instructions 342, to implement a network computing system such as described with an example of FIG. 1. The executable instructions stored in the memory 320 may also implement a method, such as described with an example of FIG. 2.

As such, examples described herein are related to the use of the computer system 300 for implementing the techniques described herein. According to an aspect, techniques are performed by the computer system 300 in response to the processor 310 executing one or more sequences of one or more instructions contained in the memory 320. Such instructions may be read into the memory 320 from another machine-readable medium, such as the storage device 340. Execution of the sequences of instructions contained in the memory 320 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

Supplier or Line Terminal

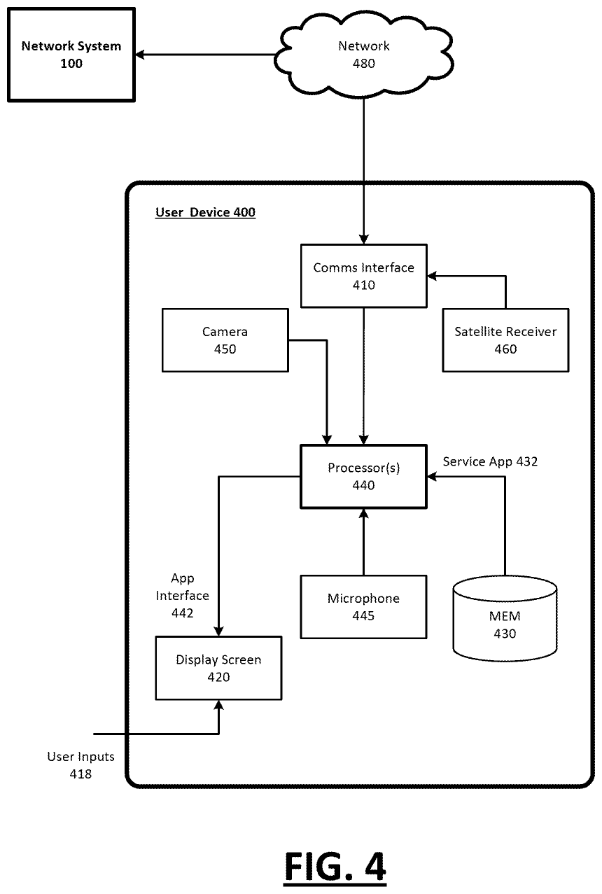

FIG. 4 is a block diagram illustrating an example supplier or line terminal for use with examples as described. In an example, a user device 400 is operable by a supplier or food preparer to execute a designated service application for a network service implemented through a network computing system 100, such as described with an example of FIG. 1. In many implementations, the user device 400 can include a mobile computing device, such as a smartphone, tablet computer, laptop computer, VR or AR headset device, and the like. As such, the user device 400 can include typical telephony and/or tablet features such as a microphone 445, a camera 450, a satellite receiver 460, and a communication interface 410 to communicate with external entities using any number of wireless communication protocols. In certain aspects, the user device 400 can store a designated service application (e.g., a service app 432) in a local memory 430. In variations, the memory 430 can store additional applications executable by one or more processors 440 of the user device 400, enabling access and interaction with one or more host servers over one or more networks 480.

In response to a supplier input 418 (e.g., supplier input 141), the service application 432 can interact with the user device 400 to display an application interface 442 on a display screen 420 of the user device 400. When the user device 400 is used as a consumer device, the application interface 442 can be used to display, for example, the estimated arrival time of a transportation provider, or information about a preparation step, in order to enable the respective supplier personnel to implement steps for preparing food items of an order request in accordance with a target completion time communicated from the system 100.

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computing system comprising:
one or more processors;
a memory to store a set of instructions;
wherein the one or more processors access the instructions to:
receive an order request from a requesting consumer;
communicate at least a first portion of the order request to a first supplier;
coordinate a completion time of at least the first portion of the order request with an estimated arrival time of a transportation provider at a location of the first supplier, wherein the one or more processors coordinate the completion time by determining a timing of when at least a step in a preparation of at least the first portion of the order request is performed, based on the estimated arrival time of the transportation provider; and
wherein the one or more processors coordinate the completion time by performing one or more coordination actions to promote the determined timing with at least the first supplier.

2. The network computing system of claim 1, wherein the one or more processors coordinate the completion time by determining the estimated arrival time for a selected or prospective transportation provider to travel to a location of the first supplier.

3. The network computing system of claim 1, wherein the one or more processors coordinate the completion time by estimating a time interval to select a transportation provider for delivering the order request when complete.

4. The network computing system of claim 3, wherein the one or more processors access the set of instructions to:
monitor a plurality of transportation providers in a given region that includes a location of the first supplier;
estimate, from monitoring the plurality of transportation providers, a number of available transportation providers for delivering the order request, at one or more instances after the order request is received; and
wherein the estimated time interval to select the transportation provider is based at least in part on an estimated number of available transportation providers.

5. The network computing system of claim 1, wherein the one or more processors access the instructions to:
select a transportation provider for delivering the order request; and
determine the estimated time until transport for the order request can be initiated by repeatedly predicting a trip duration of the transportation provider from a current location to a location of the first supplier.

6. The network computing system of claim 5, wherein the one or more processors update the timing of when at least the step in the preparation of at least the first portion of the order request is performed based on the predicted trip duration.

7. The network computing system of claim 1, wherein the one or more processors access the instructions to predict a preparation time of the at least first portion of the order request; and
wherein the one or more processors determine the timing of when at least the step in the preparation of at least the first portion of the order is performed based on the predicted preparation time.

8. The network computing system of claim 1, wherein the one or more coordination actions include delaying communication of at least the first portion of the order request to the first supplier.

9. The network computing system of claim 1, wherein the one or more coordination actions include communicating an instruction to the first supplier to delay an intermediate step in the preparation of at least the first portion of the order request.

10. The network computing system of claim 1, wherein the one or more processors access the instructions to:
select the transportation provider for the request;
instruct the transportation provider to arrive at a location of the first supplier within a designated time period of a predicted completion time of the first portion of the order request;
monitor a progress of the selected transportation provider in traveling to the location of the first supplier; and
wherein the one or more actions include an action to affect when an intermediate step in the preparation of at least the first portion of the order request is performed.

11. The network computing system of claim 1, wherein the one or more processors predict a preparation time of individual items of the order request, and wherein the one or more processors coordinate the completion time based on a food item of the order request that has the longest preparation time.

12. The network computing system of claim 1, wherein the one or more processors communicate a second portion of the order request to a second supplier, and wherein the one or more processors coordinate the completion time by predicting when the second portion of the order request is to be complete relative to when the first portion of the order request is to be complete.

13. The network computing system of claim 12, wherein the one or more processors access the instructions to trigger when the second supplier is to initiate preparation of the second portion of the order request based on an estimated completion time of the first portion of the order request.

14. The network computing system of claim 12, wherein the one or more processors coordinate a completion time of at least the second portion of the order request by triggering when the second supplier is to initiate preparation of the second portion of the order request based on a predicted arrival time of a selected transportation provider at a location of the first supplier.

15. The network computing system of claim 14, wherein the one or more processors trigger when the second supplier is to initiate preparation of the second portion of the order request based at least in part on a type of food item that is included in the order request.

16. The network computing system of claim 14, wherein the one or more processors trigger when the second supplier is to initiate preparation of the second portion of the order request based at least in part on one of (i) a distance between a location of the first supplier and a location of the second supplier, or (ii) a distance between the location of the second supplier and a location of the requesting consumer.

17. The network computing system of claim 1, wherein the one or more actions include communicating instructions to initiate or pause preparation of a particular food item of at least the first portion of the order.

18. The network computing system of claim 1, wherein the one or more actions include communicating instructions to initiate or pause a preparation step of a particular food item of at least the first portion of the order.

19. A method for coordinating timing of delivery services, the method being implemented by one or more processors and comprising:
receiving an order request from a requesting consumer;
communicating at least a first portion of the order request to a first supplier;
coordinating a completion time of at least the first portion of the order request with an estimated arrival time of a transportation provider at a location of the first supplier, wherein the one or more processors coordinate the completion time by determining a timing of when at least a step in a preparation of at least the first portion of the order request is performed, based on the estimated arrival time of the transportation provider; and
wherein coordinating the completion time includes performing one or more coordination actions to promote the determined timing with at least the first supplier.

20. A non-transitory computer-readable medium that stores instructions, which when executed by one or more processors of a network computing system, cause the network computing system to perform operations that include:
receiving an order request from a requesting consumer;
communicating at least a first portion of the order request to a first supplier;
coordinating a completion time of at least the first portion of the order request with an estimated arrival time of a transportation provider at a location of the first supplier, wherein the one or more processors coordinate the completion time by determining a timing of when at least a step in a preparation of at least the first portion of the order request is performed, based on the estimated arrival time of the transportation provider; and
wherein coordinating the completion time includes performing one or more coordination actions to promote the determined timing with at least the first supplier.
